(19) United States
(12) Patent Application Publication
(10) Pub. No.: US 2008/0295525 A1
(43) Pub. Date: Dec. 4, 2008

(54) MULTIPLE ROTARY VALVE FOR PULSE TUBE REFRIGERATOR

(76) Inventors: Mingyao Xu, Saitama (JP); Eric Seitz, Allentown, PA (US)

Correspondence Address: KATTEN MUCHIN ROSENMAN LLP, 575 MADISON AVENUE, NEW YORK, NY, 10022-2585, US

(21) Appl. No.: 12/189,973

(22) Filed: Aug. 12, 2008

Related U.S. Application Data
(63) Continuation of application No. 11/910,088, filed on Oct. 25, 2007.

(51) Int. Cl. F25B 9/00; F16K 11/074

(52) U.S. Cl. 62/6; 137/625.46

(57) ABSTRACT

A rotary disc valve unit and refrigerators containing a rotary disc valve unit that has multiple valves, in which at least one rotary valve has ports connecting to the regenerator and at least one rotary valve has ports connecting to the warm ends of one or more pulse tubes where the rotary valve with ports for the regenerator has lighter contact than the rotary valve with ports for the pulse tubes. The valve face is divided into an inner area with ports for the pulse tubes and an outer area with ports for the regenerator, the inner area having a greater sealing pressure than the outer area.

### BACKGROUND

The present invention relates to GM type pulse tube refrigerators. The pulse tube type expanders of such cryogenic refrigerators include a valve mechanism, which commonly consists of a rotary valve disc and a valve seat. There are discrete ports, which, by periodic alignment of the different ports, allow the passage of a working fluid, supplied by a compressor, to and from the regenerators and working volumes of the pulse tubes. In U.S. Pat. No. 3,205,668, Gifford discloses a multi-ported rotary disc valve that uses the high to low pressure difference to maintain a tight seal across the face of the valve. This type of valve has been widely used in different types of GM refrigerators as shown for example in U.S. Pat. Nos. 3,620,029, 3,625,015, 4,987,743, 6,694,749 and PCT/US2005/001617.

W. E. Gifford conceived of an expander that replaced the solid displacer with a gas displacer and called it a “pulse tube” refrigerator. This was first described in his U.S. Pat. No. 3,237,421 which shows a pulse tube connected to valves like the earlier GM refrigerators. GM type pulse tubes running at low speed are typically used for applications below about 20 K. It has been found that best performance at 4 K has been obtained with the pulse tube shown in FIG. 9 of U.S. Pat. No. 6,256,998. This design has six valves which open and close in the sequence shown in FIG. 11 of that patent.

PCT/US2005/007981 provides an improved means of reducing the wear rate and the torque required to turn a multi-port rotary disc valve by maintaining very light contact or a very small gap between the face of the valve disc and the seat. It provides means to reduce the wear rate and the torque by having a bearing hold the valve seat and/or disc such that they are not in contact with each other, or have light contact each other. However, it is found that the performance of the refrigerator is very sensitive to the clearance between the face of the valve disc and seat for a pulse tube refrigerator which has ports connecting between the compressor and the warm end of the pulse tubes, such as a pulse tube refrigerator shown in FIG. 9 of U.S. Pat. No. 6,256,998.

U.S. Pat. No. 6,460,349 describes a rotary valve unit for a pulse tube that has two valve discs, one that cycles flow between the compressor and the regenerator, and another that cycles flow between a pulse tube and a buffer volume, the improvement being to have high pressure gas on the outside of the valves and low pressure gas at the center for the purpose of controlling leakage to be from the outside toward the center.

Other art describes a spool valve that has close clearance radial ports that control the flow between the compressor and the regenerator and axial ports at the end of the rotating spool that control flow between the compressor and the pulse tubes. The axial ports are in the rotating face of the spool and are in sliding contact with a stationary seat. A sealing pressure on the axial ports is provided by the differential pressure loading between the two ends of the spool.

### SUMMARY

In the course of exploring different valve concepts it has been found that a rotary disc valve unit can be designed that has multiple valves, in which at least one rotary valve has ports connecting to the regenerator and at least one rotary valve has ports connecting to the warm ends of one or more pulse tubes. The rotary valve with ports for the regenerator has lighter contact than the rotary valve with ports for the pulse tubes. Leakage from the ports to the regenerator has a small impact on performance because it represents a small loss of gas flowing into the expander. Leakage of flow to a pulse tube however can result in dc flow in the pulse tube, which can result in a large loss of cooling capacity, and can also cause the temperature to be unstable.

The ports that control flow to the pulse tubes typically have less than 10% of the area of the ports that control flow to the regenerator. It is thus practical to divide the valve face into an inner area with ports for the pulse tubes and an outer area with ports for the regenerator, the inner area having a greater sealing pressure than the outer area. Leakage in the pulse tube ports is thus minimized while the low sealing pressure on the outer area of the valve disc reduces the torque required to turn the valve. The wear rate of the valve is also reduced.

Such a valve arrangement improves the performance, reliability and temperature stability of a pulse tube refrigerator that uses a multi-ported rotary valve. Other types of pulse tubes that can benefit from this invention include four valve type, active-buffer type, five-valve type, and inter-phase type. U.S. Pat. No. 6,629,418 is an example of an inter-phase pulse tube that has two regenerators and multiple pulse tubes.

This disclosure provides an improved means of reducing the leakage of flow to pulse tubes while minimizing the torque required to turn a multi-port rotary disc valve. This is accomplished by having multiple rotary valves, in which one rotary valve with ports connecting to the regenerator has light sealing pressure, and a second rotary valve with ports connecting to pulse tubes has a greater sealing pressure.

Leakage through the ports that control flow to and from the pulse tubes can upset the dc flow pattern and the phase shift. Both are critical to the performance, reliability and temperature stability of a pulse tube refrigerator. It is essential to have good contact between the seat face and the disc face to minimize the leakage. Larger contact pressure on the face of a rotary valve with pulse tube ports makes better contact between the disc face and the seat face, thus the leakage through the clearance between the seat face and the disc face is reduced. Leakage through the face of a rotary valve with regenerator ports is not as critical as that of a rotary valve with pulse tube ports thus the sealing pressure can be less. This in turn reduces the torque required to turn the valve.

A number of different valve arrangements are disclosed that incorporate these principles in different ways.

### BRIEF DESCRIPTION OF THE DRAWINGS

FIG. 1 is a cross section of a first embodiment of a valve assembly in accordance with the present invention in which small schematics of the compressor and a single stage 4-valve orifice pulse tube refrigerator are included to show the flow relations. The valve disc with pulse tube ports is inserted inside the valve disc with regenerator ports. The valve disc housing is at low pressure and the valve discs can move axially. The valve seat is fixed.

FIG. 2 is a cross section of a second embodiment of a valve assembly in accordance with the present invention in which the valve disc with pulse tube ports is located inside the valve disc with regenerator ports. The valve disc housing is at low pressure. The outer valve disc is fixed axially while the valve seat can move axially.

FIG. 3a is a face view of a dual valve disc for the valve units of FIGS. 1 and 2.

FIG. 3b is a face view of the valve seat for the valve units of FIGS. 1 and 2.

FIG. 4 is a cross section of a third embodiment of a valve assembly in accordance with the present invention. It is a variation of the valve assembly shown in FIG. 2, in which the valve seat has a step in it at a different pressure than the base of the valve seat.

FIG. 5 is a cross section of a fourth embodiment of a valve assembly in accordance with the present invention. It is a variation of the valve assembly shown in FIG. 1 in which the valve disc housing is at high pressure.

FIG. 6 is a cross section of a fifth embodiment of a valve assembly in accordance with the present invention. It is a variation of the valve assembly shown in FIG. 5 in which the inner valve disc has a step in it at a different pressure than the side opposite the sliding face.

FIG. 7 is a cross section of a sixth embodiment of a valve assembly in accordance with the present invention. It has a single rotary valve disc, but the seat has an inner section that can move axially relative to the outer part of the valve seat which is fixed. The valve disc can move axially. The valve disc housing is at low pressure while the back side of the inner valve seat is at high pressure.

FIG. 8 is a cross section of a seventh embodiment of a valve assembly in accordance with the present invention. It is a variation of the valve assembly shown in FIG. 7, in which the valve disc is fixed but both the inner and outer valve seats can move axially. The valve disc housing is at low pressure while the back sides of both valve seats are at high pressure.

FIG. 9 is a cross section of an eighth embodiment of a valve assembly in accordance with the present invention. It is a variation of the valve assembly shown in FIG. 8, in which the base of the outer valve seat is connected to the pulse tube buffer volume and is thus at an intermediate pressure.

FIG. 10 is a cross section of a ninth embodiment of a valve assembly in accordance with the present invention. It is a variation of the valve assembly shown in FIG. 7, in which the inner valve seat has a step in it that is at low pressure.

FIG. 11 is a cross section of a tenth embodiment of a valve assembly in accordance with the present invention. It is a variation of the valve assembly shown in FIG. 1, in which the axial force along the motor drive shaft is carried by a bearing that is independent of the motor bearings

FIG. 12 is a cross section of an eleventh embodiment of a valve assembly in accordance with the present invention. It is a variation of the valve assembly shown in FIG. 11, in which some of the axial force associated with the valve disc is carried by a bearing that is mounted on the valve seat. The valve disc housing is at high pressure.

FIG. 13 is a cross section of a twelfth embodiment of a valve assembly in accordance with the present invention. It is a variation of the valve assembly shown in FIG. 12, in which the valve disc housing is at low pressure.

FIG. 14 is a cross section of a thirteenth embodiment of a valve assembly in accordance with the present invention. Two valve discs are shown back to back, rotating against separate valve seats. Differential pressure forces push the two valve discs apart and into contact with the opposing valve seats.

FIG. 15 is a cross section of a fourteenth embodiment of a valve assembly in accordance with the present invention. Two valve discs are shown rotating against opposite sides of a central valve plate. Differential pressure forces push the two valve discs into contact with the two faces of the valve plate.

FIG. 16 is a cross section of a fifteenth embodiment of a valve assembly in accordance with the present invention. A dual rotating valve disc is shown in which the inner disc has ports for the pulse tube and the outer disc has ports for the regenerator. This embodiment differs from all of the previous embodiments in that the valve disc housing is at the pressure of the buffer volume.

FIG. 17 is a cross section of a sixteenth embodiment of a valve assembly which is a variation of the valve assembly shown in FIG. 16. The valve disc housing is at buffer pressure but the valve disc is a single integral structure.

### DETAILED DESCRIPTION

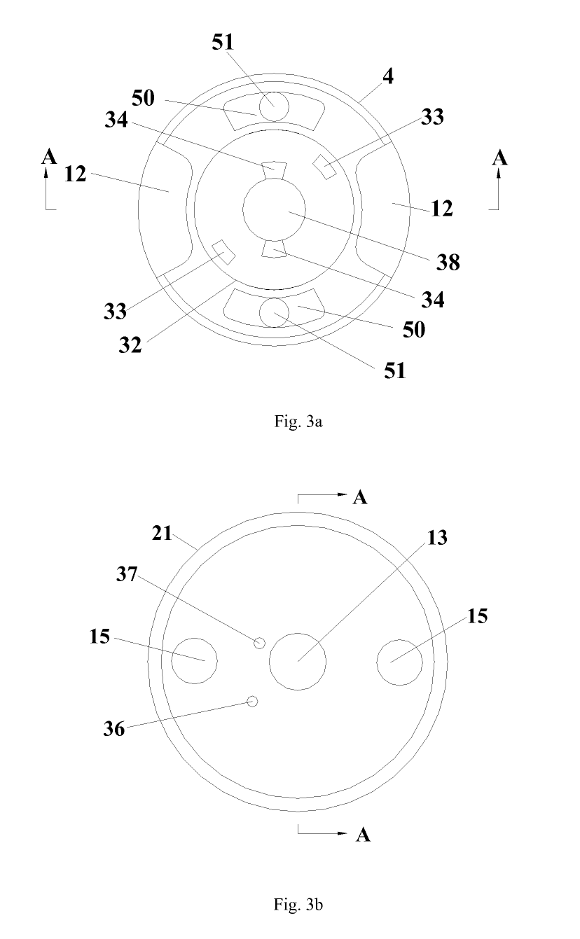

The present invention is applicable to any kind of G-M type pulse tube refrigerators in which gas is cycled in and out of the warm end of a regenerator and pulse tubes by a valve unit. It is of particular value when applied to low temperature pulse tubes that have multi-stages and multi-ports. All of the figures, except FIGS. 3 and 17, illustrate different means of having different forces applied to the face area of a valve that controls the flow to one or more pulse tubes than to the face area of a valve that controls the flow to the pulse tube regenerator.

This ability to design the valve with more force on the pulse tube port area than the regenerator port area enables the leakage at the pulse tube ports to be less than port leakage at the regenerator. The consequence of the differential pressures applied is that the torque required to turn the valve can be minimized.

In the following FIGS. like numbers are used for like parts.

FIG. 1 shows a cross section of valve assembly 29 along with small schematics of the compressor and a single stage four-valve orifice pulse tube refrigerator to show the flow relations.

Valve unit 29 has a valve motor assembly 5, a valve housing 7 and a valve seat housing 17, all of which are sealed by means of a variety of ‘O’-ring seals, and by bolts 1. A valve seat 21 is held and sealed within valve seat housing 17. An outer valve disc 4 is turned by valve motor 5 through a motor shaft 6 and drive pin 3 passing through shaft 6. Outer disc 4 is free to move axially relative to pin 3. Outer disc 4 is in contact with valve seat 21. Pin 3 also holds valve disc holder 2 which is sealed in outer disc 4 by ‘O’-ring 9. Inner valve disc 32 is located in outer disc 4. Valve disc 32 turns together with outer disc 4 through pins 8 but it is free to move axially. It is sealed in outer disc 4 by ‘O’-ring 31. Springs 30 and 40 are used to keep inner disc 32 and outer disc 4 in contact with valve seat 21 when the refrigerator is off. Port 10 in valve disc housing 7 connects through low pressure return line 18 to compressor 20.

Gas at high pressure flows from compressor 20 through line 19 and enters valve seat housing 17 at port 14. High pressure gas flows through port 13 in seat 21 to the center of the valve face. It continues to flow through center port 38 in inner valve disc 32 into cavity 11 which is formed within inner disc 32, outer disc 4, and valve holder 2. As inner valve disc 32 rotates, high pressure gas flows through slot 34 as it passes over port 37 in valve seat 21, then through port 41 in valve seat housing 17, to pulse tube 25, and through orifice 27 to buffer volume 28. Gas entering the warm end of pulse tube 25 flows through flow smoother 26.

Gas returns from pulse tube 25 and buffer volume 28 through port 41 in housing 17 then to the face of inner valve disc 32 through port 36 in valve seat 21. It is connected to low pressure in valve disc housing 7 through port 33 in inner valve disc 32. The channel that connects port 33 to low pressure is not shown in this drawing.

As outer valve disc 4 rotates, port 51, shown in FIG. 3a, connects high pressure gas in cavity 11 to regenerator 22 as it passes over port 15 in valve seat 21. From the bottom end of port 15 gas flows through port 16 in seat housing 17 to the warm end of regenerator 22. Gas exits the cold end of regenerator 22 and flows to pulse tube 25 through line 23 and cold end flow smoother 24. When outer valve disc 4 rotates so that slot 12 in disc 4 passes over port 15 in seat 21, gas returns from the cold end of pulse tube 25 through regenerator 22 and ports 15 and 16 to low pressure in housing 7.

Valve seat 21 is prevented from rotating by pin 35, and does not move axially because the differential pressures on valve discs 4 and 32 and the effective areas are designed to have the discs push down against seat 21.

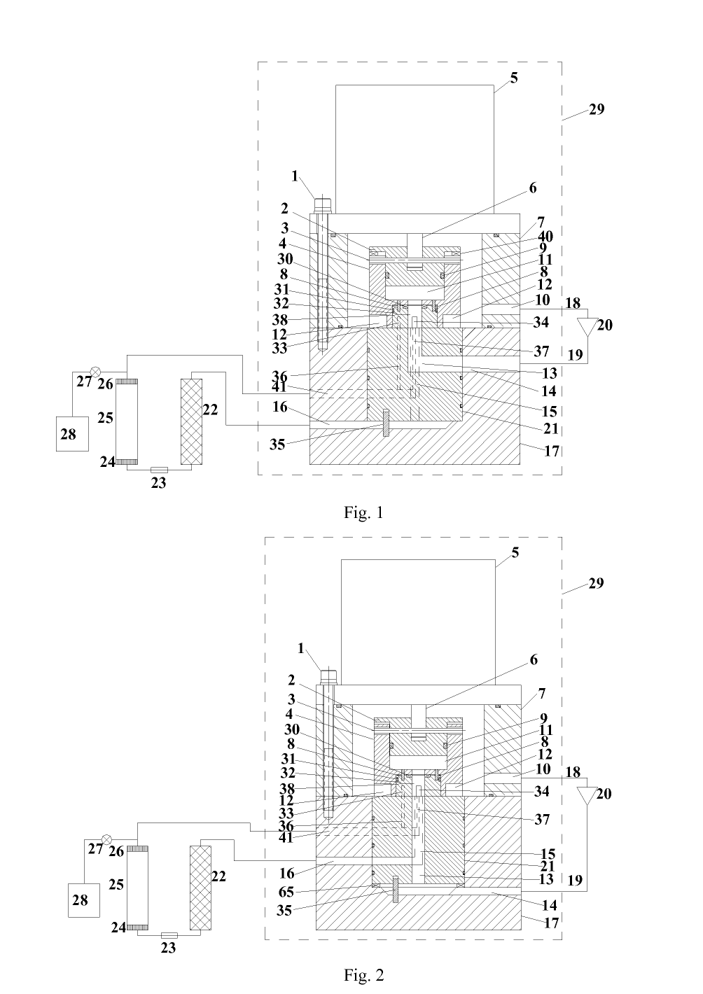

FIG. 2 is a cross section of a second embodiment of a valve assembly which differs from FIG. 1 in that drive pin 3 fixes outer valve disc 4 from moving axially while valve seat 21 can move axially. Like parts are numbered the same. FIG. 2 shows high pressure at the bottom of seat 21 rather than the pressure of gas flowing to and from the regenerator as shown in FIG. 1. The differential pressures on valve disc 32 and seat 21 and the effective areas are designed to have seat 21 push up against disc 4, and disc 32 is pushed down against seat 21.

FIGS. 3a and 3b show the valve ports for FIGS. 1 and 2. The cross sections shown in FIGS. 1 and 2 are noted by section arrows A-A in FIGS. 3a and 3b. FIG. 3a shows the gas flow cavities in the face of outer disc 4 and inner disc 32. FIG. 3b shows the ports in the face of seat 21. High-pressure, Ph, gas flows from center port 13 in seat 21 through center port 38 in disc 32 to cavity 11, shown in FIGS. 1 and 2. It then flows through a port 51, which connects to cavity 11, to cavity 50. Regions 12 that are under cut in the outer edge of outer disc 4 connect to low-pressure, Pl, gas that returns to the compressor. As valve discs 4 and 32 rotate, cavities 50 with high pressure gas and cavities 12 that connect to low pressure, alternately pass over ports 15 in seat 21, and cycle gas to the regenerator. Inner valve disc 32 has cavities 34 that have high pressure gas in them, and cavities 33 that connect, through channels that are not shown. As valve disc 32 rotates over ports 36 and 37 in seat 21, high pressure gas flows to the pulse tube through 34 and 37, then gas returns to low pressure through 33 and 36.

Although not essential to an understanding of the invention, a refrigeration cycle will be briefly described with reference to FIGS. 1, 2, and 3.

FIGS. 1 and 2 show a four-valve orifice type pulse tube refrigerator driven by the invented valve unit. It consists of a regenerator 22, a pulse tube 25 with warm end flow smoother 26 a cold end flow smoother 24, and a cold end heat exchanger 23. Buffer orifice 27 and buffer volume 28 are parts of phase shifter. By rotating outer disc 4 against valve seat 21 by means of valve motor 5 and shaft 6, holes 15 and 16, which communicate with the inlet of regenerator 22, are alternately pressurized by gas flowing through slots 50 and depressurized by flow through cavities 12.

By rotating inner disc 32 together with outer disc 4, holes 36, 37 and 41, which communicate with the warm end of pulse tube 25, are alternately pressurized by gas flowing through slots 34 and depressurized by flow through slots 33. The phase shift in pulse tube 25 is controlled by adjusting the timing and rate of gas flowing through slots 33 and slots 34, and rate of gas flowing from buffer volume 28 through orifice 27. The porting shown in FIGS. 3a and 3b produce two complete cycles to pressurize and depressurize the pulse tube for every rotation of outer disc 4 and inner disc 32. It is to be understood that the expander can be operated with one, or more than one, cycle per cycle of the rotary valve by properly arranging the supply and return porting on discs 4 and 32, and valve seat 21.

Having described two variations of valve assemblies in accordance with the present invention, as illustrated in FIGS. 1 and 2, and a possible valve disc design as illustrated in FIG. 3, an example is given of the design process that provides sealing pressures for both outer disc 4 and inner disc 32 against seat 21. With reference to FIG. 1 there is a force, Fi, which is generated from the differential pressure between the supply pressure, Ph, exerted on the distal face of disc 32, Ai, and the average pressure exerted on the face of disc 32, Pvi, that keeps the face of disc 32 in contact with the face of valve seat 21. Spring force, Fsi, from spring 30 adds to the sealing force. The face of disc 32, in this example, has the same area, Ai, as the distal surface. Force Fi is given by the equation,

Fi=Ai*(Ph−Pvi)+Fsi Equation 1

The exterior surfaces of outer disc 4 and valve holder 2 are surrounded by gas at low-pressure, Pl. The surface of outer disc 4 that is in contact with valve seat 21 is at an average pressure, Pvo, which varies as the disc rotates. The pressure across the face of outer disc 4 has gradients between the high pressure in slot 50 and the outer perimeter, which is at low pressure. The pressure distribution across the face of outer disc 4 changes as it rotates and alternately has high-pressure gas flow into port 15 then lets low-pressure gas flow out. The force, Fo, required to have outer disc 4 seal against the face of seat 21 is greatest when it seals ports 15 against high-pressure gas, and is minimum when the face of outer disc 4 seals ports 15 against low-pressure gas. The force required to have a seal across the face of outer disc 4 is obtained by having the product of the pressures and areas on the distal side of outer disc 4 be greater than the product of the maximum average pressure on the face of outer disc 4 and the area of the face of outer disc 4, Ao. This can be expressed in the form of an equation in which Aoc is the area of the distal side of outer disc 4 in cavity 11, which is acted upon by Ph, and Aod is the annular area of the distal side of outer disc 4 between the outer diameter of Aoc and valve face Ao, which is acted upon by Pl. Spring 40 also contributes to the sealing force, Fso.

Fo=Aod*Pl+Aoc*Ph+Fso−Ao*Pvo Equation 2

Experience has shown that the variation of Pvo during a cycle results in a variation of torque that is on the order of 15% of the average torque. Because disc 32 has a smaller diameter than disc 4, the sealing force Fi can be greater than Fo and the torque required to turn the valve can be reduced.

The sealing force for inner valve disc 32 in FIG. 2 is the same as Equation 1. Since outer disc 4 in FIG. 2 is fixed, sealing force Fo is derived from the pressure differentials on the face and distal surfaces of valve seat 21. The distal surface of valve seat 21 has area Asd which is acted upon by pressure Ph. For this case the sealing force on outer valve disc 4 is,

Fo=Asd*Ph−Ao*Pvo−Fi Equation 3

The sealing pressure, Pi, on the valve area that controls the flow to the pulse tube is equal to Fi/Ai. Similarly the sealing pressure on the valve area that controls flow to the regenerator, Po, is equal to Fo/Ao.

Equations 1 to 3 are intended to serve as examples of the principals that can be used to calculate the sealing pressures for the balance of valve configurations to be disclosed. The designer has great latitude in providing surfaces that enable a desired sealing pressure to be achieved. Although the expander shown in FIG. 1 is a single stage pulse tube, it is also possible to design the valve unit and porting so that it can be used to drive a multi-stage pulse tube with multiple control ports. By properly arranging the porting on discs 4 and 32, and the valve seat 21, and by arranging necessary passages to communicate with the warm end of the pulse tube 25, the disclosed valve unit can also be used to drive other types of pulse tube refrigerators which have ports on a valve unit connecting to the warm end of pulse tubes, such as, four valve type, active-buffer type, five-valve type, and inter-phase type.

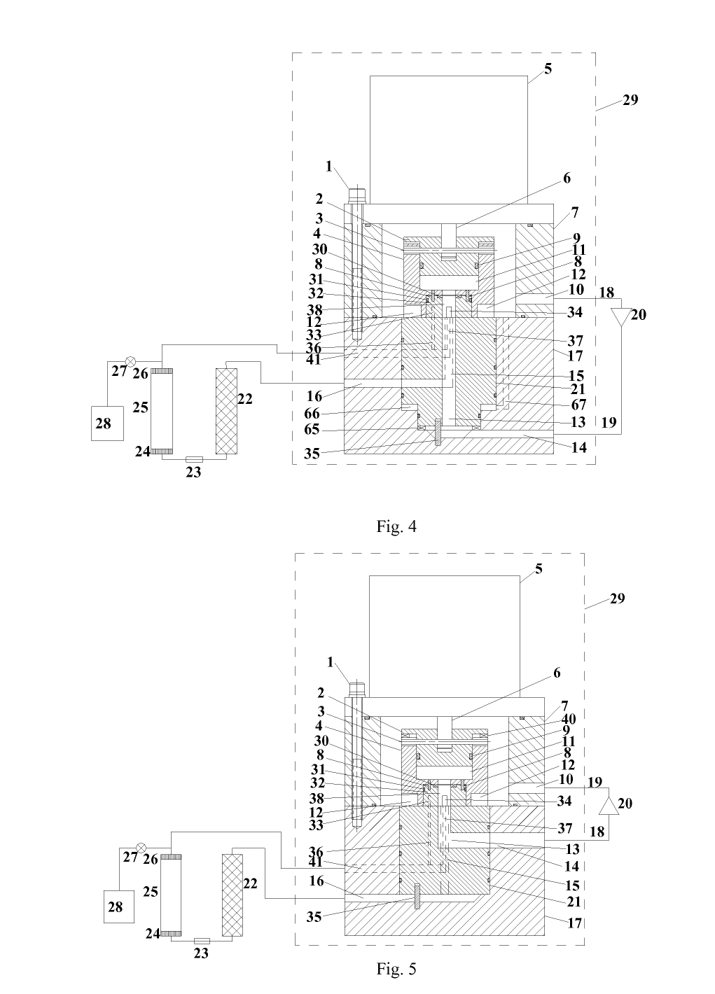

FIG. 4 is a cross section of a third embodiment of a valve assembly in which the valve seat has a step in it at a different pressure than the base of the valve seat. Like the configuration shown in FIG. 2 outer valve disc 4 is fixed axially by pin 4. The area of the distal end of the center of valve seat 21 that is at pressure Ph has been reduced and step 66 which is connected to pressure Pl through channel 67 has been added.

FIG. 5 is a cross section of a fourth embodiment of a valve assembly that is a variation of the valve assembly shown in FIG. 1. Connections to compressor 20 have been reversed so high pressure supply line 19 connects to port 10 and low pressure return line connects to port 14. This puts high pressure gas in valve disc housing 7 and low pressure gas in center ports 13 and 38, and valve disc cavity 11. With reference to Equation 1 the pressure on the distal surface of inner disc 32 is changed from Ph to PI thus spring force Fsi has to be increased to provide the desired sealing pressure.

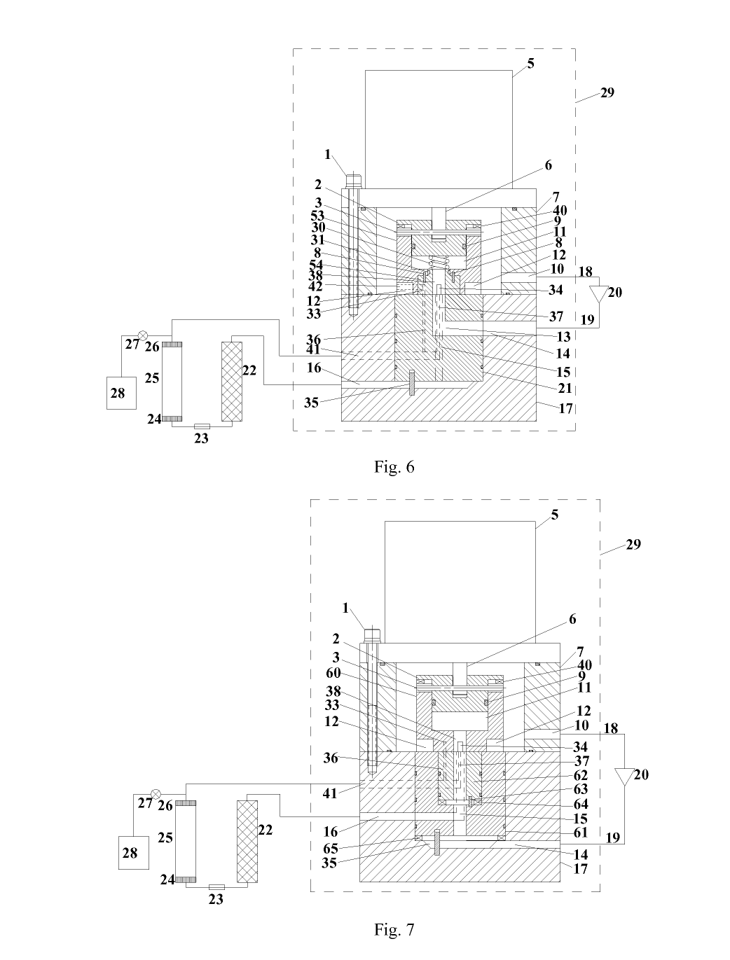

FIG. 6 is a cross section of a fifth embodiment of a valve which is a variation of the valve assembly shown in FIG. 5. It differs in that inner valve disc 54 and outer valve disc 53 have a step which is at a pressure between Ph and Pl as determined by the pressure on valve seat 21 at the boundary between discs 53 and 54.

FIG. 7 is a cross section of a sixth embodiment of a valve assembly which has an integral rotary valve disc. The seat has an inner section that can move axially relative to the outer part of the valve seat. Integral valve disc 60 is attached to valve holder 2 by drive pin 3 but is free to move axially. Valve seat 61 has an inner seat 62 that can move axially. It is in contact with the area of the face of valve disc 60 that controls flow to the pulse tube. The area of the face of valve disc 60 that lies outside of inner seat 62 controls flow to the regenerator. Pin 63 prevents inner seat 62 from rotating. Spring 40 pushes valve disc 60 down against the seat while springs 64 and 65 push seats 62 and 61 respectively up against disc 60. In this embodiment, outer valve seat 61 can be fixed axially or free to move.

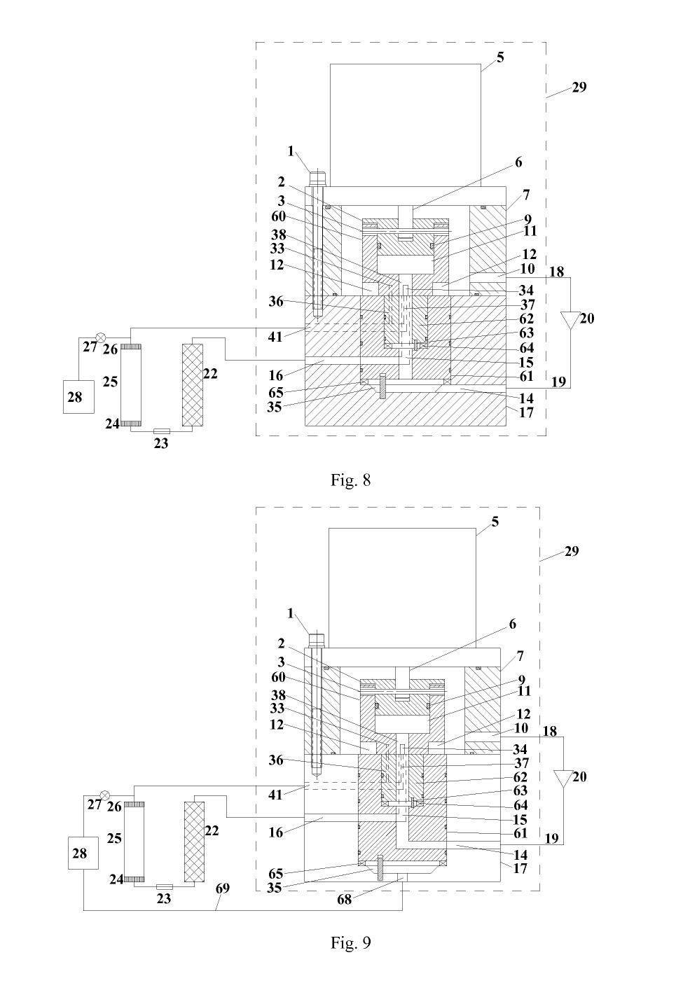

FIG. 8 is a cross section of a seventh embodiment of a valve assembly that is a variation of the valve assembly shown in FIG. 7. In this embodiment valve disc 60 is fixed axially by drive pin 3. Both the inner valve seat 62 and outer valve seat 61 can move axially. Springs 64 and 65 contribute to the sealing pressures at the face in contact with valve disc 60.

FIG. 9 is a cross section of an eighth embodiment of a valve assembly that is a variation of the valve assembly shown in FIG. 8. Channel 14, which brings high pressure gas into the center of valve seat 61, is moved so that the distal end of seat 61 can be connect to the intermediate pressure in buffer volume 28 by line 69 and port 68.

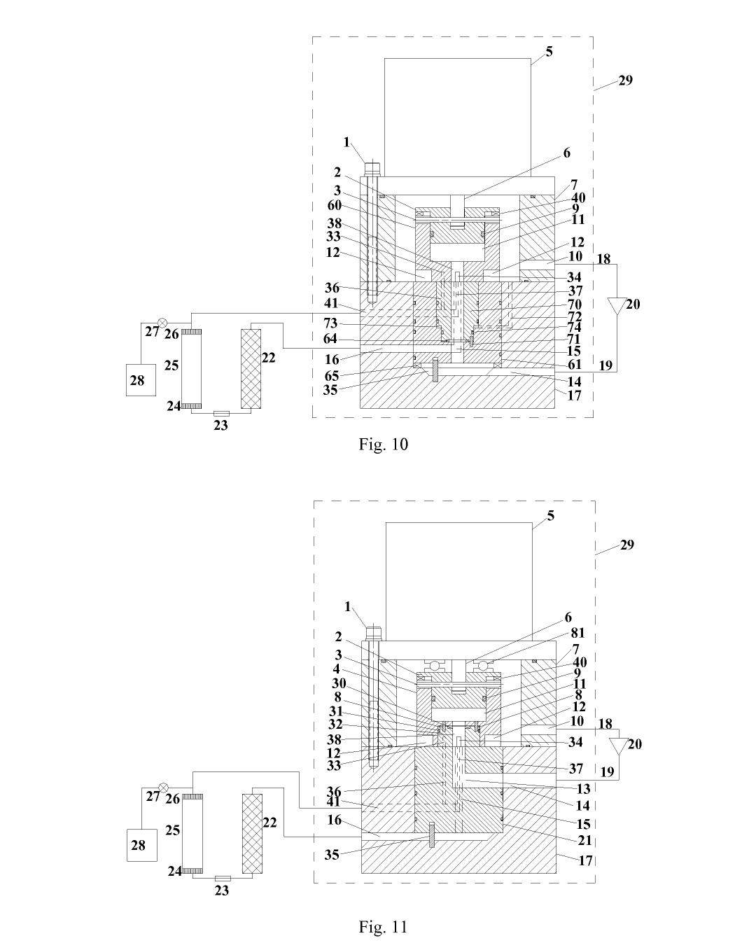

FIG. 10 is a cross section of a ninth embodiment of a valve assembly that is a variation of the valve assembly shown in FIG. 7. Inner valve seat 70 and outer valve seat 61 are configured to have step 73 that is sealed on the smaller diameter by “O” ring 74. Pin 71 prevents inner seat 70 from rotating. Both seats, 61 and 70, can move axially. Step 73 is connected to Pl through channel 72.

FIG. 11 is a cross section of a tenth embodiment of a valve assembly that is a variation of the valve assembly shown in FIG. 1. In this embodiment, the axial force, that is carried by shaft 6 to the bearings in motor 5 in FIG. 1, is carried by bearing 81.

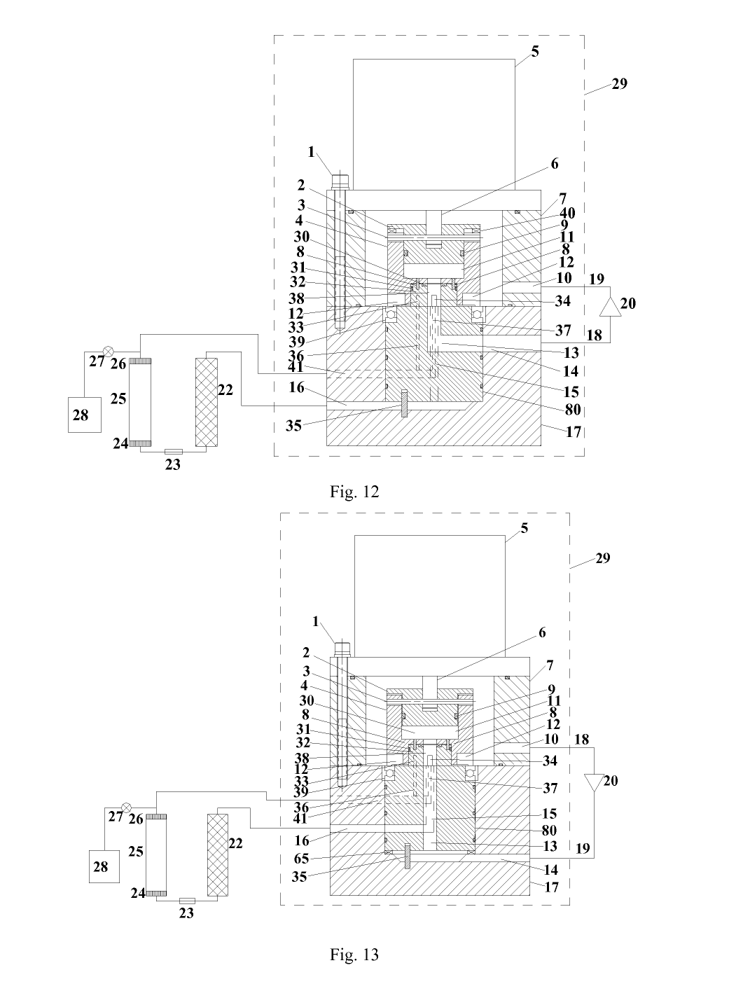

FIG. 12 is a cross section of an eleventh embodiment of a valve assembly that is a variation of the valve assembly shown in FIG. 11. In this embodiment the force of outer valve disc 4 against seat 80 is carried primarily by bearing 39 which is mounted on 80. Outer valve disc 4 can be in light contact with seat 80, or there can be a small clearance between them.

FIG. 13 is a cross section of a twelfth embodiment of a valve assembly that is a variation of the valve assembly shown in FIG. 12. This embodiment differs from that of FIG. 12 in that valve disc housing 7 is at low pressure and outer valve disc 4 is fixed by pin 9 to motor shaft 6. Differential pressure and spring 65 keep seat 80, which can move axially, in contact with outer valve disc 4.

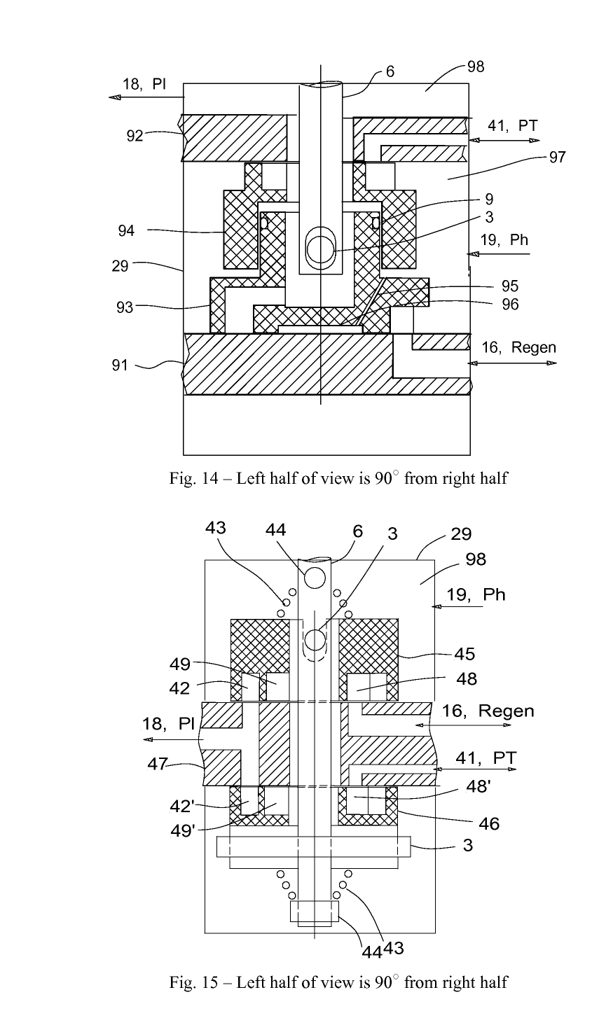

FIG. 14 is a cross section of a thirteenth embodiment of a valve assembly in which there are two valve discs mounted back to back, rotating against separate valve seats. Upper valve disc 94 rotates against upper valve seat 92 and controls flow to the pulse tube. Lower valve disc 93 rotates against valve seat 91 and controls flow to the regenerator. Differential pressure forces push the two valve discs apart and into contact with the opposing valve seats. Motor shaft 6 and the space around it are at Pl, as is the cavity between upper valve disc 94 and lower valve disc 93. “O” ring 9 seals the inner space at Pl from the space around the valve disc which is at Ph. Lower valve disc 93 can have a cavity 96 in its face which is connected to Ph through port 95.

FIG. 15 is a cross section of a fourteenth embodiment of a valve assembly in which two valve discs are shown rotating against opposite sides of a central valve plate. Upper valve disc 45 rotates against the upper face of seat 47 and controls flow to the regenerator. Lower disc 46 rotates against the lower face of seat 47 and controls flow to the pulse tube. Differential pressure forces, and springs 43, push the two valve discs into contact with the two faces of valve seat 47. Springs 43 are retained by pins 44. Valve discs 45 and 46 can move axially. They have gas at Ph on all faces except where they contact valve seat 47. This embodiment shows a novel means of channeling the flow to low pressure from the regenerator through port 16 into recess 48 in the face of upper valve 45, then into annular groove 42 and around to port 18 at Pl. A similar arrangement is used in lower valve disc 46 where gas flows to low pressure from the pulse tube through port 41, then through recess 48′ and annular groove 42′ to port 18 at Pl. High pressure gas is cycled to port 16 and the regenerator through recess 49 in upper valve disc 45. Similarly high pressure gas is cycled to port 41 and the pulse tube through recess 49′ in lower valve disc 46.

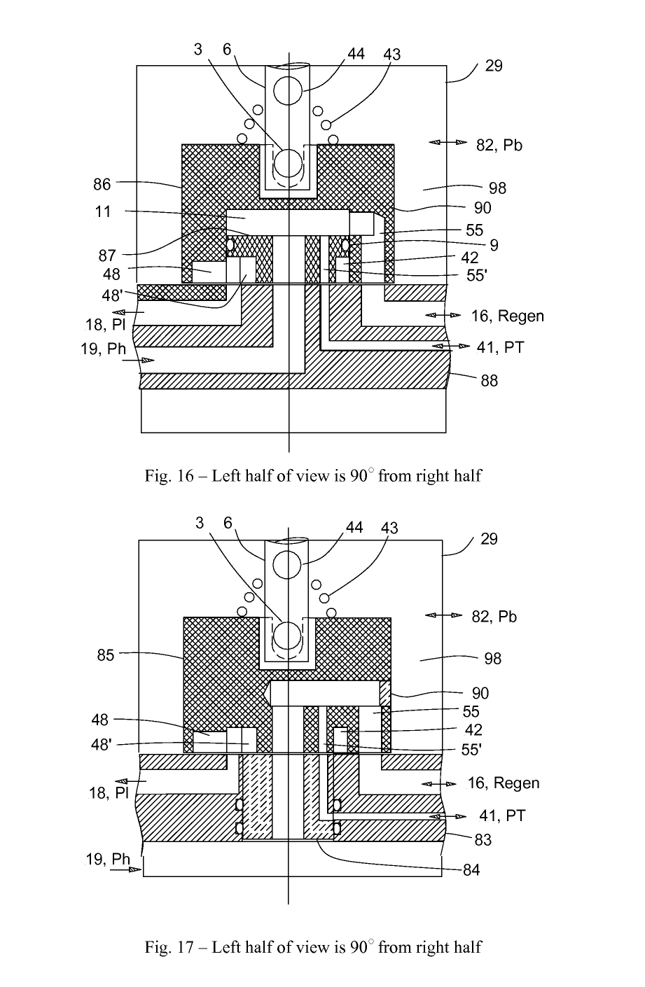

FIG. 16 is a cross section of a fifteenth embodiment of a valve assembly that has a dual rotating valve disc that is surrounded by gas at buffer pressure. Inner valve disc 87 has ports 55′ and 48′ that alternately cycle high and low pressure gas to the pulse tube through port 41 in valve seat 88. Outer valve disc 86 has ports 55 and 48 that alternately cycle high and low pressure gas to the regenerator through port 16 in valve seat 88. Space 98 around outer valve disc 86 is connected to the pulse tube buffer volume through port 82. Central cavity 11 formed between outer disc 86 and inner disc 87, sealed by “O” ring 9, is connected to Ph through port 19 in valve seat 88 and a central channel in disc 87. Gas returns to low pressure from the regenerator through recess 48 in outer disc 88, annular channel 42 in inner disc 87, and port 18. Similarly gas returns to low pressure from the pulse tube through recess 48′ in inner disc 87, annular channel 42 in inner disc 87, and port 18.

This embodiment is novel in having space 98 around valve disc 90, including the volume in the housing of motor 5, connected to pulse tube buffer volume 28 shown in FIG. 1. In effect this space is the pulse tube buffer volume.

FIG. 17 is a cross section of a sixteenth embodiment of a valve assembly which is a variation of the valve assembly shown in FIG. 16. It differs in having a single piece valve disc 85, but the space around it, 98, is at buffer pressure and the porting is the same as shown in FIG. 16. The inner section of disc 85 that controls flow to the pulse tube is integral with the outer section that controls flow to the regenerator. Outer valve seat 83 has an inner seat 84 that is free to move axially. It can be designed to apply greater sealing pressure to the central area of disc 85, which controls flow to the pulse tube, than the outer area, which controls flow to the regenerator.

It is to be recognized that the embodiments used to illustrate the concept of having the sealing area for the region of a rotary face type valve that controls flow to the pulse tube have a different sealing pressure than the region that controls flow to the regenerator, leave it up to the designer to determine what the sealing pressures will be.

While this disclosure teaches that greater sealing pressure for the region that controls flow to the pulse tube is desirable to minimize leakage and thus improve performance, it is not obvious in looking at the final parts that this effect has been achieved. It is thus assumed that a valve assembly that incorporates the disclosed concepts is practicing the teachings of this disclosure.

1. A GM type pulse tube refrigerator, comprising:
valves for controlling flow to and from one or more pulse tubes and a regenerator, said valves consisting of ports in a rotary disc that communicate intermittently with ports in an opposed non-rotating seat, said rotary disc having gas at a buffer pressure on the external surfaces not in contact with said seat.

2. A GM type pulse tube refrigerator in accordance with claim 1, wherein the valves are included in a multi-port rotary disc valve assembly, the assembly comprising:
a valve disc and a valve seat where the disc and the seat each have ports contained therein located such that the ports on the disc and the ports on the seat communicate intermittently as one of the disc and seat move in relation to the other;
where the area of the disc that contains the port that controls flow to the pulse tubes is distinct from the area of the disc that contains the port that controls flow to the regenerator.

3. A GM type pulse tube refrigerator in accordance with claim 2, wherein, in the valve assembly, the area of the disc that contains the port that controls flow to the pulse tubes has greater contact pressure than the area of the disc that contains the port that controls flow to the regenerator.

4. A GM type pulse tube refrigerator in accordance with claim 2, wherein, in the valve assembly, ports in the central area of the disc are connected to one or more pulse tubes and ports in the outer annular disc are connected to a regenerator.

5. A GM type pulse tube refrigerator in accordance with claim 4, wherein, in the valve assembly, the valve disc comprises a central disc that is axially moveable within the bore of an outer annular disc.

6. A GM type pulse tube refrigerator in accordance with claim 4, wherein, in the valve assembly, the valve seat comprises a central seat that is axially moveable within the bore of an outer annular seat.

7. A GM type pulse tube refrigerator in accordance with claim 2, wherein, in the valve assembly, a force that brings the valve disc into a sealing relation with the valve seat is due to gas at different pressures acting on the distal surfaces of said disc and said seat, with or without force from a spring.

8. A GM type pulse tube refrigerator in accordance with claim 7, wherein, in the valve assembly, the distal surfaces may include one of a stepped surface in a valve disc and a stepped surface in a valve seat.

9. A GM type pulse tube refrigerator in accordance with claim 7, wherein, in the valve assembly, a net difference in the force may be carried by one of drive motor bearings and a separate bearing.

10. A GM type pulse tube refrigerator in accordance with claim 7, wherein, in the valve assembly, a bearing that supports the disc relative to the seat in the area of the disc containing the port that controls flow to one or more regenerators is used to minimize the sealing pressure of the valve.

11. A valve assembly comprising:
a non-rotating valve seat; and
a multi-port disc valve arranged opposed to the non-rotating valve seat, the multi-port disc valve to control flow to and from one or more pulse tubes and a regenerator, said multi-port disc valve including valves consisting of ports in a rotary disc that communicate intermittently with ports in the non-rotating valve seat, said rotary disc having gas at buffer pressure on the external surfaces not in contact with the non-rotating valve seat;
wherein the disc and the seat each have ports contained therein located such that the ports on the disc and the ports on the seat communicate intermittently as one of the disc and seat move in relation to the other; and
wherein the area of the disc that contains the port that controls flow to one or more pulse tubes is distinct from the area of the disc that contains the port that controls flow to a regenerator.

12. A valve assembly in accordance with claim 11 in which the area of the disc that contains the port that controls flow to the one or more pulse tubes has greater contact pressure than the area of the disc that contains the port that controls flow to the regenerator.

13. A valve assembly in accordance with claim 11 in which ports in the central area of the disc are connected to one or more pulse tubes and ports in the outer annular disc are connected to a regenerator.

14. A valve assembly in accordance with claim 11 in which the forces that bring the valve discs into a sealing relation with the valve seats are due to gas at different pressures acting on the distal surfaces of said disc and said seat, with or without force from a spring.
